(19) United States
(12) Patent Application Publication
(10) Pub. No.: US 2009/0259529 A1
(43) Pub. Date: Oct. 15, 2009

(54) Method for personalized advertising on communication device

(75) Inventors: Che-Liang Chiu, Taipei City (TW); Hsiao-Cheng Wei, Taichung City (TW); Jen-yi Pan, Minsyong Township (TW)

Correspondence Address: Muncy, Geissler, Olds & Lowe, PLLC, P.O. BOX 1364, FAIRFAX, VA, 22038-1364, US

(73) Assignees: Che-Liang Chiu; Hsiao-Cheng Wei

(21) Appl. No.: 12/081,164

(22) Filed: Apr. 11, 2008

(51) Int. Cl. G06Q 30/00

(52) U.S. Cl. 705/14

(57) ABSTRACT

The present invention discloses new communication device advertising methods for implementing the same. One method discloses by the present invention features downloading the personalized information while making a call; the method comprises the steps of: providing a request signal from the communication device to an information system after a dialing signal is generated on the communication device; generating personalized information, which is the combination of advertising data and value added information, by the information system according to said request signal and advertising data; playing the advertising data on the communication device; after the playing is finished, sending the dialing signal by the communication device to make a call; calculating bonus relating to the call; the user can also decide whether to play the value-added information or not after the call. Another method is pre-downloading the personalized information first and plays it without downloading it while making a call. The present invention also discloses a method for avoiding the dial fraud; the dial fraud means bonus earned by the user from the call exceeds communication fee of that call.

### FIELD OF THE INVENTION

The present invention relates to a method for advertising on a communication device, and more particularly, to a method for personalized advertising on a communication device.

### DESCRIPTION OF THE PRIOR ART

Recent technological advances in digital user interfaces have added versatility to communication devices by enabling users to access text and graphics information over the screen of the device and therefore it is desirable to sending a targeted advertisement, that is, direct advertising, to the target group or specific user via communication device like cell phone, PDA and note book. The advantages claimed by direct advertising include sending directly to a group with potential interest, but it is hard to make sure the information is indeed viewed/listened by the target user. The other questions includes the willingness of a user to receiving this information, avoiding cheating.

U.S. Pat. No. 6,993,326 discloses a method and system for providing targeted advertisement information to consumers over a wireless communications network. This invention discloses that as a wireless device enters a cell site near the location of the advertiser, a message is delivered to the wireless device specified by the local advertiser. If an acknowledgement signal is sent back, the local advertiser's account is charged for transmission of the advertisement. The invention also discloses that the message is associated with one or more demographic codes, and users of wireless communications device select from more demographic codes to describe their advertisement preferences. Messages to be transmitted to particular wireless communications devices are selected based upon both the location information and the demographics codes that are associated with the messages. U.S. Pat. No. 7,103,368 discloses a network navigation center receives current position information from a mobile communication device carried by automobile via a mobile telephone network access point and a public telephone network, and then transmits the advertisement information based on current position information to the mobile communication instrument via the public telephone network and mobile telephone network access point. These inventions relate to a kind of passive advertising, which isn't triggered by or doesn't relate to making a call.

United States patent application No. 20070198339 discloses a method of generating relevant promotional materials for transmission to a mobile device includes receiving a query from the mobile device, identifying a plurality of advertisements associated with an advertiser-directed delivery parameter that match parameters for the mobile device, and generating a response to the query comprising search results and the plurality of advertisements. The invention doesn't disclose methods and system for implementing a communication device advertising while a user is making a call and assuring the information is viewed/listened by the user.

In view of the present inventions, they haven't provided a system and methods conquering the questions mentioned above. The inventor disclosed the invention described below.

### SUMMARY OF THE INVENTION

The present invention discloses new communication device advertising methods and system for implementing the same. One method discloses by the present invention features downloading the personalized information while making a call; the method comprises the steps of: providing a request signal from the communication device to an information system after a dialing signal is generated on the communication device; generating personalized information, which is the combination of advertising data and value added information, by the information system according to said request signal and advertising data; playing the advertising data on the communication device; after the playing is finished, sending the dialing signal by the communication device to make a call; calculating bonus relating to the call; the user can also decide whether to play the value-added information or not after the call. Another method is pre-downloading the personalized information first and plays it without downloading it while making a call. The present invention also discloses a system and a method for avoiding the dial fraud; the dial fraud means bonus earned by the user from the call exceeds communication fee of that call.

The present invention discloses a system and a method for generating the personalized advertisement.

The present invention discloses a system and a method relating to providing incentive for user to receive the advertisement.

The present invention discloses a system and a method for assuring the user receiving and playing the advertisement.

The present invention discloses a system and a method for selecting suitable advertisement items according the user's tags, user's location, the dial number and the log analysis.

The present invention discloses a system and a method for implementing personalized advertising more correctly and smoothly according to a decision making process.

### BRIEF DESCRIPTION OF THE DRAWINGS

FIG. 1 illustrates a system for the communication device advertising according to the present invention.

FIG. 2 illustrates a flow chart relating to implementing the present invention.

### DESCRIPTION OF THE PREFERRED EMBODIMENT

The invention will now be described in greater detail with preferred embodiments of the invention and illustrations attached. Nevertheless, it should be recognized that the preferred embodiments of the invention is only for illustrating. Besides the preferred embodiment mentioned here, present invention can be practiced in a wide range of other embodiments besides those explicitly described, and the scope of the present invention is expressly not limited expect as specified in the accompanying Claims.

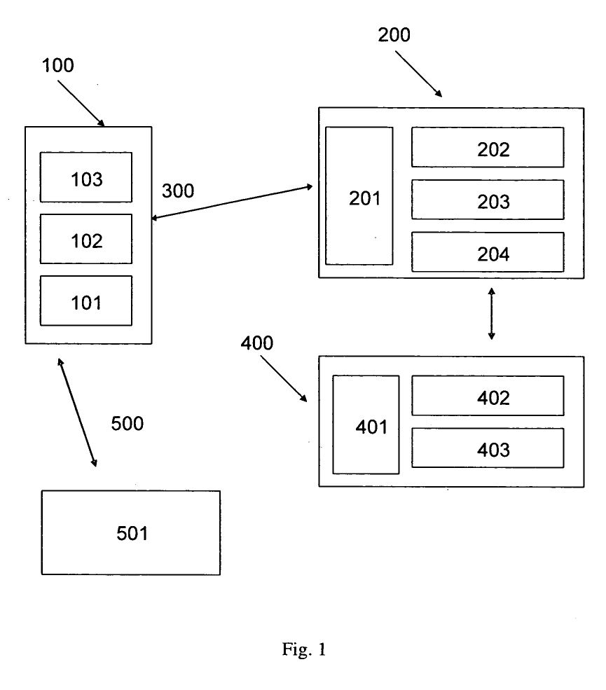

The present invention relates to a system for implementing communication device advertising on the communication device. The system illustrated in FIG. 1 comprises multiple communication devices 100, a information system 200 communicating with the communication devices 100, a network interface 300 for establishing and maintaining a communication link between the information system 200 and the communication devices 100 for retrieving the personalized information, e.g. the combination of advertising data and value-added information, a storage server 400 coupled to the information system 200 for storing and retrieving information, a communication link 500 for connecting to a telephony server 501; wherein the telephony server 501 is for establishing a call between the communication devices.

The communication device 100 comprises a user interface 101 for generating a dialing signal; a processing unit 102 coupled to the user interface 101 for performing decision making process; receiving, transmitting and processing the data, including the dialing signal, the personalized information, the request signal, user's preference data . . . and so on; and building the desired communication links to send and/or receive the signals; and a local storage 103 for storing data; the communication device 100 also has two network interfaces coupled to the processing unit 102 for receiving and transmitting signals. The request signal includes user's tags, user's identity, location and callee identity. The callee identity means the dialing numbers; due to privacy protection issue, the callee identity is hashed by a hash function, e.g. MD5 or SHA-1; more specifically to say, the callee identity is hashed before transmission while the callee identity isn't empty. In a preferred embodiment, the user's tag is defined by the user.

The information system 200 comprises an interface 201 for receiving the request signal from the communication device 100, and then generating user's preference data according to the request signal. In another embodiment, the user's preference data is stored in the communication device 100 and sent to the login server 200 with the request signal; therefore, the information system 200 only transfer the request signal to the processing unit 202 without generating user's preference data. The user's preference data is user's tag including the user's identity, preference, location, and the callee identity; the “tag” means a keyword or term associated with or assigned to a specific classification of information. In a preferred embodiment, the user's preference data also includes the operation history of the user and/or the tolerable time length of the advertisement defined by the user.

In a preferred embodiment, the system 200 also includes a processing unit 202 coupled to a preference database 203 for performing the “matching” operation for generating the suitable personalized information, including finding the desired information stored in the storage server 400; wherein the preference database 203 stores the data relating to the attribution of the advertising data, including attribution of the information, the tag, the length and so on, for matching with the user's preference data; more specifically to say, the advertising data includes advertising object or preference data uploaded by an advertiser, reference data associated with bonus calculating . . . and so on.

In a preferred embodiment, while the desired information is found in the storage server 400, the processing unit 202 also provides a format transforming function to make sure that the communication device 100 receives playable information. In one embodiment, the format provided by the interface 201 includes a mp3,mp4, mpg, wmv, qt, avi, dat, or other commonly used video and audio compression standard; In a preferred embodiment, the format also includes Hyper Text Markup Language (HTML), XHTML and other format for displaying texts with interactive forms, embedded images, and other objects displayable on the communication device 100; therefore, a value-added message is added to the information (advertising data) found in the storage server 400. In another embodiment value added information is combined with the advertising data that is the information founded on the storage server 400, to produce the personalized information. In a preferred embodiment, the user can decide to play the value added information or not.

In a preferred embodiment, the server 200 also includes a bonus unit 204 for calculating the feedback bonus for each call and for avoiding dial fraud; more specifically to say, the bonus calculating is performed according to the calculating base set in the bonus unit 204; avoiding dial fraud means preventing a caller getting more bonus than the communication fee he spent.

The storage server 400 comprises an advertisement database 401 for retrieving and/or storing the information required for the advertising. In one embodiment, the processing unit 402 and the preference data 403, which are the equivalent unit to the processing unit 202 and the preference database 203 functionally, are established in storage server 400 for generating the personalized information. In a preferred embodiment, the multiple storage servers 400 are separated established according to the information category or the advertisers.

The present invention is applicable to a wired or a wireless environment. In one embodiment, the communication device advertising means mobile advertising and therefore, the communication devices 100 mentioned above is a mobile communication device including a cell phone, smart phone or other mobile communication devices and therefore the network 300 can access the Internet.

In a preferred embodiment, the communication device 100 is a notebook or a personal computer, or any communication device equipped with a Voice over Internet Protocol (VoIP) software, and the network 300 is Internet or other packet switched networks; in another embodiment, the voice call is connected to a telephony server 501 and a communication link can be one of transmission network types of GSM, GPRS, 3G, WiMax, fixed line, and ADSL.

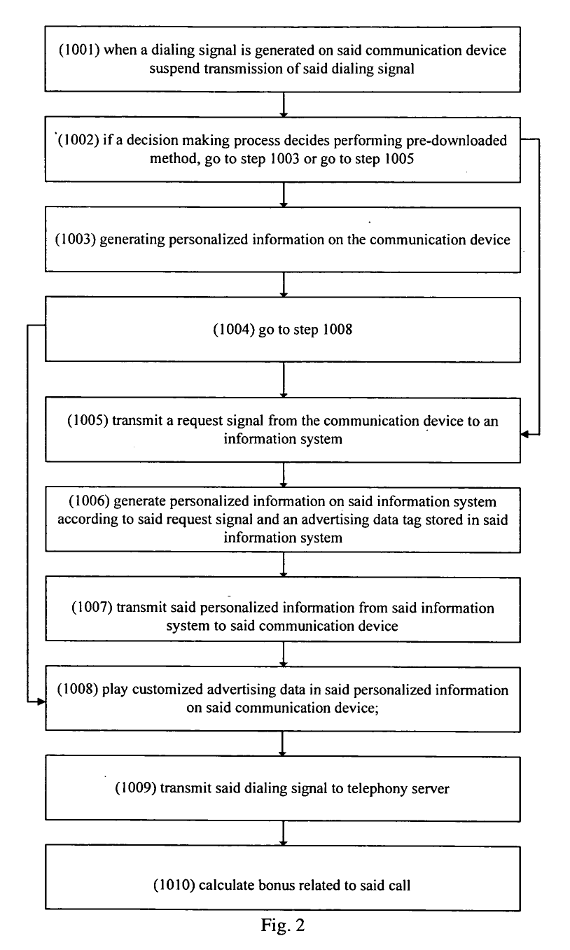

The present invention also discloses a method for the communication device advertising. Referring to the system shown in FIG. 1 and steps shown in FIG. 2, while a user makes a call by user interface 101 in step 1001, the present invention provides two methods for implementing the communication device advertising. The streamline method is that playing one part of the advertisement data while downloading the rest; the pre-downloading method is playing the advertising data pre-downloaded and stored in the local storage 103 of the communication device 100. In a preferred embodiment, the preferred method is decided by a decision making process.

The decision making process is implemented according to several criteria, including the connectivity to the Internet, the fresh level of the advertisements and the matching accuracy of the matching mechanism; more specifically to say, the criteria includes: (1) reliability of network connectivity; (2) network traffic load; (3) timestamps of personalized information in the local storage 103; (4) how many times a piece of personalized information in the local storage 103 is played; and (5) the level of match between the personalized information in the local storage 103 and the criteria, including the user's preference and the location data. In one embodiment, if the connectivity to the Internet and the bandwidth is acceptable, for example, within the acceptable range of the delay of sound or video image, the streamline mode is the preferred one. In another embodiment, when the communication device detects that the reliability of network connectivity is acceptable, network traffic load is not high, the timestamps of personalized information in said local storage shows the information is old according to the date of downloading, or the personalized information has been played many times, or level of match is not good, or the combination thereof, the pre-downloading mode is initiated. In a preferred embodiment, the weights of each criterion is changed when the user makes the call in different situation; the situation includes the communication environment, the configuration set by the user, the operation mode, the scenario set by the advertiser . . . and so on.

In step 1002, performing the decision making process for deciding which method is executed; while the streamline method is selected, the step goes to step 1005, the processing unit 102 is triggered by the dialing signal and then communication between the communication device 100 and the information system 200 is established but the dialing signal is hold and stored in the communication device 100; more specifically to say, a connection is established through a network 300. In a preferred embodiment, a network 300 includes wired or wireless communication connected to the Internet.

Upon establishing a connection, the processing unit 102 also transmits a request signal relating to the dialer's characteristics to the information system 200; in a preferred embodiment, the dialer's characteristics includes the information relating to or provided by the user; for example, one of the dialer's characteristics is the location of the communication device 100; in one embodiment, the location information is retrieved by mobile device or the network status. Any position method is able to applied to retrieve the location information, such as Cell-ID, Enhanced Observed Time Difference(E-OTD), Time of Arrival (TOA), Wireless Assisted GPS (A-GPS), Global Positioning System (GPS) or Internet Protocol Address. The dialer's characteristics also include the playable format of the communication device 100, the dialed number and operational histories.

Next, in step 1006, generating personalized information by the information system 200 According to said request signal and the data relating to the attribution of the advertising data. First, retrieving the user's preference data stored in the information system 200 by request signal; in another embodiment, the user's preference data is stored in the communication device 100 and sent to the information system 200 along with the request signal. In one embodiment, the preference data includes the profile of, or the tags defined by the user; the “tag” means a keyword or term associated with or assigned to a specific classification of information. In a preferred embodiment, the preference data also includes the operation history of the user and/or the tolerable time length of the advertisement defined by the user. In another preferred embodiment, the playable format on the communication device 100 is also detected.

Next, the matching mechanism is used to select the suitable the advertising data. The user's preference data is matching with the data relating to attribution of advertising data, for example a tag, to generate the direct advertising data. The data relating to attribution of advertising data is established by an advertiser for matching with the user's preference data mentioned above to generate a direct advertising data; more specifically to say, the advertising data includes the target of the advertising, the time length of the information. The step for “matching” includes comparing the user's preference data and the data relating to attribution of advertising data to find the corresponding categories in storage server 400. In one embodiment, multiple storage servers 400 are separated established and the direct advertising data is generated in the information system 200; accordingly, the direct advertising data generated in the information system 200 is redirected to a specific storage sever 400 according the corresponding information category. In another embodiment, if the processing unit 402 and preference database 403 is established in storage sever 400, the process for generating a direct advertising data is proceed in storage server 400; therefore, in this embodiment, the information system 200 only transfers the user's preference data or request signal to the coupled storage server 400.

In a preferred embodiment, further information is added to the selected information found in the server 400; in one embodiment, a piece of sound is added; in another embodiment, a banner is added to the video clip. In a preferred embodiment, a piece of message, for example, a coupon, a short message or a multimedia message, is sent with the personalized information. In a preferred embodiment, the format of the message includes Hyper Text Markup Language (HTML), XHTML and other format for displaying texts with interactive forms, embedded images, and other objects displayable on the communication device 100. In a preferred embodiment, a piece of value added information is added in this step; the value added information is selected according to the matching process similar to that described above or is found with the advertising data.

In a preferred embodiment, the format of personalized information is transformed before sent back to the communication device 100 to make sure that the communication device 100 receives playable information.

While the personalized information is sent back to the communication device 100, the downloading information is also recorded. In another preferred embodiment, the personalized information is an interactive message; therefore, after the user does some response, the response is sent back to the server and recorded.

After sending the personalized information back to the communication device 100 in step 1007; Next, in step 1008, the personalized information is played on the communication device 100. After the playing is finished, the dialing signal is starting to dial out by a communication link 500 in step 1009; in another embodiment, the personalized data is played on the communication device 100, while the user is dialing out. In another embodiment, the value added information is still displayed on the screen of the communication device 100 after the personalized information is played.

In another embodiment, the pre-downloading method is performed. While a user makes a call by user interface 101 in step 1001, the pre-downloading method is initiated by the decision making process in the step 1002. In the step 1003, it performs a matching process to select the suitable advertising data. The user's preference data is matching with the advertising data in the local storage 103 to generate the personalized information. In one embodiment, the matching process is comparing the user's tags with the tags attached on the advertising data to find out which advertisement has the highest matching level. In a preferred embodiment, the tags attached to the advertising data are renewed by the new preference data downloaded from the information system 200. Then, in the step 1008, the personalized information is played. After the playing is finished, the dialing signal is starting to dial out by a communication link 500 in step 1009; in another embodiment, the personalized data is played on the communication device 100, while the user is dialing out.

In one embodiment, if the matching level between the advertising data in the local storage and the user-define tag is below a certain level, that advertising data would deleted and the processing unit 102 would actively transmits a request signal relating to the dialer's preference data to the information system 200, while the communication device is not in the dialing phase; the “matching” mechanism mentioned above is initiated, and then the communication device receives the personalized information including the advertisement data and value-added information and then storing in the local storage 103 to renew the advertisements store in the local storage 103.

In next step 1010, bonus calculating is initiated, after the information system 200 receives the bill related information; the bill related information is generated after the call is finished. In one embodiment, the calculating base is set by the advertiser; for example, the bonus is calculated according to the number of times of the file has been downloaded by the specific person; in another embodiment, it is calculated according to the time length of the specific file or the number of the packets transferred.

A user may make a phone call with such a short duration, even deliberately ask the receive not to answer the call or finish the call before the receiver picks it up, and therefore a user may gain the positive profit after deducing the communication fee from the bonus earned by making this call. Therefore, a step for avoiding cheating is added in the bonus calculating step; in one embodiment, while the bonus exceeds said communication fee, the bonus is discounted or set to zero.

Although preferred embodiments of the present invention have been described, it will be understood by those skilled in the art that the present invention should not be limited to the described preferred embodiments. Rather, various changes and modifications can be made within the spirit and scope of the present invention, as defined by the following Claims.

What is claimed is:

1. A communication device advertising method, comprising the steps of:
(1). Generating a dialing signal on a communication device, and then suspending transmission of said dialing signal;
(2) Performing a decision making process for choosing a process for generating personalized information;
(3) Generating said personalized information by matching a user's tag and data relating to attribution of advertising data.
(4) Playing said personalized information on said communication device;
(5) Transmitting said dialing signal to telephony server for making a call; and then
(6) Calculating bonus related to said call, after said call is finished.

2. The communication device advertising method of claim 1, wherein said personalized information includes advertising data and value added information.

3. The communication device advertising method of claim 2, wherein said value added information still displayed on the screen of said communication device after said personalized information is played.

4. The communication device advertising method of claim 2, wherein the user of said communication device decides to play said value added information or not.

5. The communication device advertising method of claim 1, wherein said choosing is implemented according to the following criteria:
(1) Reliability of network connectivity;
(2) Network traffic load;
(3) Timestamps of pre-downloaded personalized information stored in said communication device;
(4) How many times said pre-downloaded personalized information in said communication device is Played;
(5) The level of match between said pre-downloaded personalized information and criteria, wherein said
criteria include user's preference and location.

6. The communication device advertising method of claim 5, the weight of said criterion is changed with the operation situation.

7. The communication device advertising method of claim 1, wherein said user's tag is a user-defined tag.

8. The communication device advertising method of claim 1, wherein said user's tag represent the preference of the user of said communication device.

9. The communication device advertising method of claim 8, wherein said user's tag further includes user's location or callee identity.

10. The communication device advertising method of claim 1, wherein personalized information comprises text, image, audio, video, any displayable format, interactive media, or any combinations of them.

11. The communication device advertising method of claim 1, wherein said calculating bonus includes a process for avoiding dial fraud which means said bonus earned by the user from said call exceeds communication fee of said call.

12. The communication device advertising method of claim 11, wherein said bonus is discounted if said bonus earned by the user from said call exceeds communication fee of said call.

13. The communication device advertising method of claim 11, wherein said bonus is set to zero if said bonus earned by the user from said call exceeds communication fee of said call.

14. The communication device advertising method of claim 1, wherein said process is a stream line process comprising transmitting a request signal from said communication device to an information system, wherein said generating personalized information is implemented on said information system, and said user's tag is generated according to said request signal.

15. The communication device advertising method of claim 14, wherein said request signal includes information relating to displayable format on said communication device.

16. The communication device advertising method of claim 14, wherein request signal includes information relating to preferred display duration.

17. The communication device advertising method of claim 14, wherein said request signal includes callee identity in said dialing signal.

18. The communication device advertising method of claim 17, wherein said callee identity is hashed before transmission while said callee identity isn't empty.

19. The communication device advertising method of claim 1, wherein said process is a pre-downloaded process, wherein said generating personalized information is performed on said communication device, and said advertising data is stored in said communication device.

20. The communication device advertising method of claim 19, wherein said advertising data is deleted while the matching level between said advertising data and the user's tag is below a certain level.

21. The communication device advertising method of claim 19, wherein said communication device actively send a request signal to a information system for performing said step of generating said personalized information and then said personalized information is sent back to said communication device and stored.
